(19) United States
(12) Patent Application Publication
(10) Pub. No.: US 2026/0285056 A1
(43) Pub. Date: Sep. 24, 2026

(54) IMAGE FORMING METHOD AND IMAGE FORMING APPARATUS

(71) Applicant: Konica Minolta, Inc., Tokyo (JP)

(72) Inventor: Ken NITO, Tokyo (JP)

(21) Appl. No.: 19/567,457

(22) Filed: Mar. 16, 2026

(30) Foreign Application Priority Data
Mar. 18, 2025 (JP) 2025-043605

(51) Int. Cl. B41J 2/21; B41J 3/407; C09D 11/322; C09D 11/38; C09D 11/54; D06P 5/30

(52) U.S. Cl. CPC B41J 2/2107; B41J 3/4078; C09D 11/322; C09D 11/38; C09D 11/54; D06P 5/30; D10B 2331/04

(57) ABSTRACT

The image forming method includes a step of applying an ink containing a pigment to a fabric by an inkjet method. When a lightness difference of the fabric calculated by an expression below is smaller than a reference value, an application amount of the ink in the applying step is set to be greater than a reference application amount: lightness difference ΔL*=(lightness L* measured in a state where the fabric is disposed on a standard white plate)−(lightness L* measured in a state where the fabric is disposed on a standard black plate).

The entire disclosure of Japanese Patent Application No. 2025-43605 filed on Mar. 18, 2025 is incorporated herein by reference in its entirety.

### BACKGROUND

### Technological Field

The present invention relates to an image forming method and an image forming apparatus.

### Description of Related Art

Inkjet textile printing, in which an image is formed on a fabric by an inkjet method, has been widely performed in recent years as a textile printing method because dyeing can be performed in a short time and production efficiency is high.

As ink used in inkjet textile printing, dye ink has been mainly used, but the use of pigment ink, which can omit post-treatment such as a washing step of washing away dye that has not been dissolved or reacted, has been studied.

For example, an image forming method including a step of attaching an ink containing a pigment, resin particles, and water to a fabric by an inkjet method has been disclosed (for example, Japanese Unexamined Patent Publication No. 2022-116603). As the fabric, chemical fibers such as polyester, nylon, and acrylic are used.

### SUMMARY

Incidentally, since fibers such as polyester, nylon, and acryl generally have high permeability, fabrics obtained with the use of these fibers are easy to see through to reveal skin or underwear when worn. Therefore, for example, a pigment may be contained in the fibers to make the fibers difficult to see through.

However, according to the studies of the present inventors, when an image is formed by applying a pigment ink to a fabric obtained with the use of such fibers that are difficult to see through with the use of an inkjet method, the color density of the entire region where the image is formed may become low. It is desired that such a decrease in color density can be suppressed not only when a fabric containing a pigment in the fibers is used, but also when various fabrics are used.

The present invention has been made in view of the above-mentioned problems, and it is an object of the present invention to provide an image forming method and an image forming apparatus capable of forming an image with less decrease in color density even on a fabric obtained with the use of fibers that are difficult to see through, for example.

In order to achieve at least one of the aforementioned objects, one aspect of the present invention relates to the following image forming method and image forming apparatus.
[1] An image forming method, comprising: applying an ink containing a pigment to a fabric by an inkjet method, wherein
   when a lightness difference ΔL* of the fabric calculated by an expression below is smaller than a reference value or when a content of the pigment in the fiber is greater than a reference value, an application amount of the ink in the applying is set to be greater than a reference application amount:

$$lightness difference Δ {L}^{*} = ( lightness {L}^{*} measured in a state where the fabric is disposed on a standard white plate ) - ( lightness {L}^{*} measured in a state where the fabric is disposed on a standard black plate ) .$$

[2] The image forming method according to [1] wherein
   when the lightness difference ΔL* is smaller than the reference value, in the applying, when x is the lightness difference ΔL* of the fabric, y [g/m²] is the application amount of the ink, and A [g/m²] is the reference application amount, the ink is applied so as to satisfy Expression (1) below:

$$y \geq ( - 0.023 x + 1.5 ) \times A . \qquad Expression ( 1 )$$

[3] The image forming method according to [1] or [2] wherein
   when the lightness difference ΔL* is greater than the reference value, in the applying, the ink is applied at the reference application amount.
[4] An image forming method, comprising: applying an ink containing a pigment to a fabric by an inkjet method, wherein
   in the applying, when x is a lightness difference ΔL* of the fabric calculated by an expression below, y [g/m²] is an application amount of the ink, and A [g/m²] is a reference application amount, the ink is applied so as to satisfy Expression (1) below:

$$y \geq ( - 0.023 x + 1.5 ) \times A , and \qquad Expression ( 1 )$$

$$lightness difference Δ L *= ( lightness L * measured in a state where the fabric is disposed on a standard white plate ) - ( lightness L * measured in a state where the fabric is disposed on a standard black plate ) ,$$

or when z [g/g] is a content of the pigment in the fiber, y [g/m²] is an application amount of the ink, and A [g/m²] is a reference application amount, the ink is applied so as to satisfy Expression (2) below:

$$y \geq ( 8. z + 1. ) \times A . \qquad Expression ( 2 )$$

[5] The image forming method according to [4] wherein
   when the content of the pigment in the fiber is greater than the reference value, in the applying, when z [g/g] is the content of the pigment in the fiber, y [g/m²] is the application amount of the ink, and A [g/m²] is the reference application amount, the ink is applied so as to satisfy Expression (2) below:

$$y \geq ( 8. z + 1. ) \times A . \qquad Expression ( 2 )$$

[6] The image forming method according to [4] or [5] wherein the pigment in the fiber contains a white pigment.
[7] The image forming method according to any one of [4] to [6], in the applying, the ink containing a pigment is applied to a fabric that contains 0.01 g/g or more of a white pigment in a fiber thereof by an inkjet method at an application amount of the ink of 18.6 g/m² or more.
[8] The image forming method according to any one of [1] to [7], further comprising: applying a treatment liquid containing an aggregating agent to a region of the fabric, the region being a region to which the ink is applied.
[9] The image forming method according to [8] wherein the aggregating agent contains at least one or more of an organic acid, a metal salt, and a water-soluble cationic resin.
[10] The image forming method according to any one of [1] to [4] wherein the lightness difference ΔL* of the fabric is 20 or less.
[11] The image forming method according to any one of [1] to [10] wherein the lightness L* of the fabric measured on the standard white plate is 95 or more and 100 or less.
[12] The image forming method according to any one of [1] to [11] wherein the fabric contains a polyester fiber.
[13] An image forming apparatus, comprising: an inkjet head configured to eject an ink onto a fabric; and a controller configured to control the inkjet head so as to set an application amount of the ink corresponding to a lightness difference of the fabric calculated by an expression below or to a content of a pigment in a fiber of the fabric:

$$lightness difference Δ L *= ( lightness L * measured in a state where the fabric is disposed on a standard white plate ) - ( lightness L * measured in a state where the fabric is disposed on a standard black plate ) .$$

[14] The image forming apparatus according to [13] wherein when the lightness difference is smaller than a reference value or the content of the pigment in the fiber of the fabric is greater than a reference value, the controller controls the inkjet head so as to set the application amount of ink to the fabric to be greater than a reference application amount.
[15] The image forming apparatus according to [13] wherein when x is the lightness difference ΔL* of the fabric calculated by the expression, y [g/m²] is the application amount of the ink, and A [g/m²] is a reference application amount, the controller controls the inkjet head so as to satisfy Expression (1) below:

$$y \geq ( - 0.023 x + 1.5 ) \times A . \qquad Expression ( 1 )$$

[16] The image forming apparatus according to [13] wherein when z [g/g] is the content of the pigment in the fiber, y [g/m²] is the application amount of the ink, and A [g/m²] is a reference application amount, the controller controls the inkjet head so as to satisfy (2) below:

$$y \geq ( 8. z + 1. ) \times A . \qquad Expression ( 2 )$$

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A to 1C are image diagrams in the case where ink is applied to fabrics obtained with the use of fibers having different translucency;

FIG. 2 is a flowchart of an image forming method according to the first embodiment;

FIGS. 3A and 3B are graphs illustrating the relationship between a lightness difference of a fabric and an ink application amount coefficient;

FIG. 4 is a flowchart of an image forming method according to the second embodiment;

FIGS. 5A and 5B are graphs which show the relationship between the pigment content in the fibers and the ink application amount coefficient;

FIG. 6 is a schematic diagram of an image forming apparatus; and

FIG. 7 is a block diagram illustrating a control system.

### DETAILED DESCRIPTION OF EMBODIMENTS

Hereinafter, one or more embodiments of the present invention will be described with reference to the drawings. However, the scope of the invention is not limited to the disclosed embodiments.

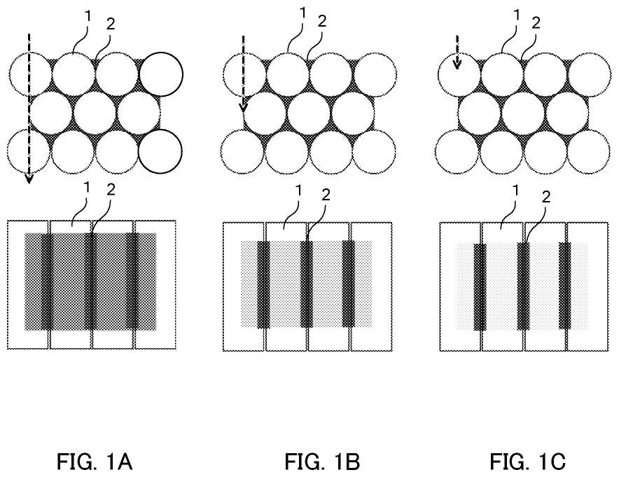

FIGS. 1A to 1C are image diagrams in the case where ink is applied to fabrics obtained with the use of fibers having different translucency. The upper part the drawing is a cross-sectional view, and the lower part is a plan view. In addition, the arrows in the drawing indicate the degree of translucency, and the translucency of fibers 1 is FIG. 1A>FIG. 1B>FIG. 1C.

As described above, when the fibers 1 constituting the fabric are fibers that do not contain a pigment and are easy to see through, the color of the ink 2 having flowed around to the back side of the fibers 1 can be visually recognized from the front side even through the fibers 1. Therefore, the color density of the entire image is less likely to decrease (FIG. 1A).

On the other hand, in the case where the fibers 1 constituting the fabric are fibers that contain a pigment and are difficult to see through, the color of the ink 2 which has turned around to the back side of the fibers 1 is difficult to visually recognize through the fibers 1 from the front side. Therefore, the color density of the entire image is more likely to decrease and the image tends to become whitish (see FIGS. 1B and 1C).

As a result of investigation by the present inventors based on these findings, it has become clear that it is effective to adjust the ink application amount (i.e., application amount of the ink) in accordance with the translucency (permeability) of the fibers of the fabric. Specifically, it has been found that a decrease in the color density of the image when visually recognized from the front side can be reduced by increasing the ink application amount as the fibers of the fabric are less likely to be seen through. Then, the present inventors have found that the translucency of the fibers of the fabric can be decided, for example, by the following: lightness difference of the fabric (the difference between the lightness of the fabric as measured on a standard white plate and the lightness of the fabric as measured on a standard black plate); and the content of a pigment in the fibers of the fabric (hereinafter, also referred to as “pigment content”). Note that the ink application amount is the amount (g) of ink applied from the inkjet head per unit surface (1 m²) of the fabric, and is an amount including solvents and the like.

That is, an image forming method of the present invention comprising applying an ink containing a pigment to a fabric by an inkjet method, wherein
when a lightness difference ΔL* of the fabric calculated by an expression below is smaller than a reference value or when a content of the pigment in the fiber is greater than a reference value, an application amount of the ink in the applying is set to be greater than a reference application amount:

$$lightness difference Δ L *= ( lightness L * measured in a state where the fabric is disposed on a standard white plate ) - ( lightness L * measured in a state where the fabric is disposed on a standard black plate ) .$$

Hereinafter, a preferred embodiment of the image forming method of the present invention will be described with reference to the drawings. However, the present invention is not limited to these embodiments.

### 1. Image Forming Method

### First Embodiment

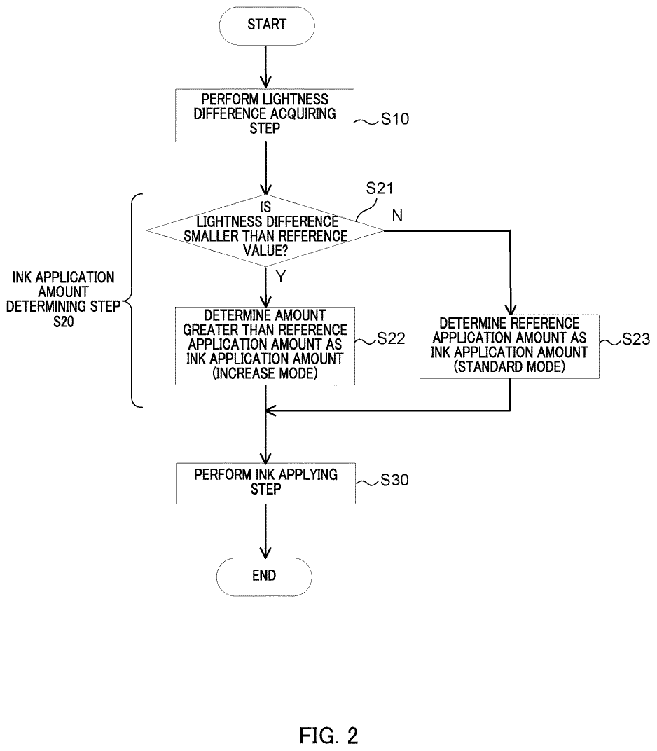

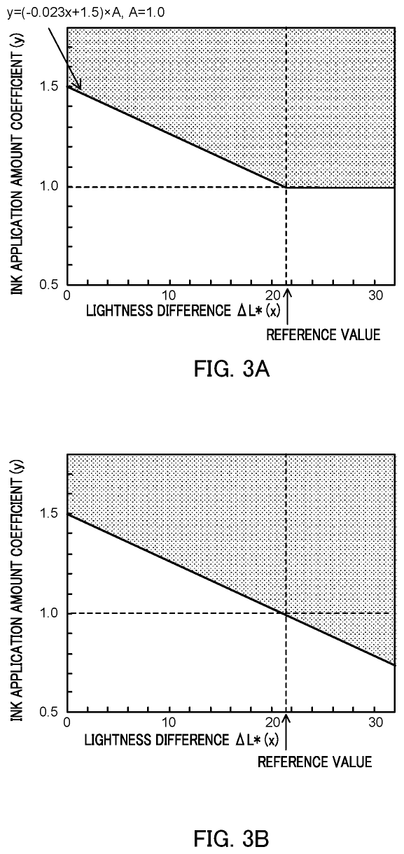

FIG. 2 is a flowchart illustrating an image forming method according to an embodiment of the present invention. FIG. 3A and FIG. 3B are graphs illustrating the relationship between the lightness difference of a fabric and the ink application amount coefficient.

As shown in FIG. 2, the image forming method according to the present embodiment includes 1) a step of acquiring the lightness difference of the fabric (acquiring step, step S10), 2) a step of determining the ink application amount based on the acquired lightness difference (ink application amount determining step, step S20), and 3) a step of applying the ink to the fabric at the determined ink application amount by the inkjet method (ink applying step, step S30).

### 1-1. Acquiring Step (step S10)

In the step S10, the lightness difference of the fabric is acquired.

The type of fiber of the fabric is not particularly limited, and examples thereof include natural fibers such as cotton, hemp, wool, and silk, and chemical fibers such as rayon, vinylon, nylon, acrylic, polyurethane, polyester, and acetate. The fabric may be any form of these fibers such as a woven fabric, a nonwoven fabric, or a knitted fabric. The fabric may also be a mixed-spun woven fabric or a mixed-spun nonwoven fabric of two or more types of fibers. In particular, the fabric preferably contains fibers of a material that is easy to adjust transparency. Examples of such a fiber include fibers of polyester, nylon, and the like, and polyester fibers are preferable.

The fibers of the fabric may contain a pigment, for example, for adjusting transparency and the like. Examples of the pigment contained in the fibers include white pigments such as titanium oxide and zinc oxide, and ceramic pigments. In particular, the pigment contained in the fibers preferably contains a white pigment. The pigment content in the fibers is not particularly limited and may be, for example, 0.02 to 0.10 g/g.

An aggregating agent may be attached to the fabric. The aggregating agent may be applied to the fabric, for example, by performing a pretreatment step described below.

The lightness difference (ΔL*) of the fabric is a difference between the lightness of the fabric when measured on a standard white plate and the lightness of the fabric when measured on a standard black plate, and is calculated by the following expression.

$$The lightness difference Δ {L}^{*} = ( lightness {L}^{*} measured in a state where the fabric is disposed on the standard white plate ) - ( lightness {L}^{*} measured in a state where the fabric is disposed on the standard black plate )$$

The lightness L* is lightness defined by the CIE L*a*b* color system.

The lightness difference (ΔL*) of the fabric is not particularly limited, but may be, for example, 20 or less, and preferably 10 or more and 20 or less. The lightness difference of the fabric can depend on, for example, the type of fiber (the type of resin), the pigment content in the fiber, and the like. For example, when the content of the pigment in the fiber is large, the lightness difference of the fabric becomes small. The lightness (L*) of the fabric is also not particularly limited. In the case of a white fabric, the lightness (L*) of the fabric is preferably 95 or more and 100 or less on a standard white plate, and is preferably 70 or more and 95 or less on a standard black plate (black trap). This is not applied in the case of colored fabrics.

The lightness difference of the fabric may be acquired by measurement, or data measured in advance may be acquired from another source.

The lightness difference of the fabric can be measured by the following method.

First, in a state where the fabric is disposed on a standard white plate, the lightness L* is measured from above the fabric. Similarly, with the fabric disposed on the standard black plate, the lightness L* is measured from above the fabric.

Next, the lightness difference ΔL* is calculated by applying each measured lightness L* to the following expression.

$$The lightness difference Δ {L}^{*} = ( lightness {L}^{*} measured in a state where the fabric is disposed on a standard white plate ) - ( lightness {L}^{*} measured in a state where the fabric is disposed on a standard black plate )$$

The lightness (L*) and the lightness difference (ΔL*) can be measured with a spectrophotometer (e.g., CM-Konica 25d manufactured by Konica Minolta, Inc) under the conditions of light sources D65/10° and field of view/SCI. As the standard white plate and the standard black plate, a standard white plate and a standard black plate (black trap) of a commonly used calibration stand can be used, respectively.

### 1-2. Ink Application Amount Determining Step (Step S20)

In step S20, the ink application amount is determined based on the acquired lightness difference. In the present embodiment, the step S20 includes the steps of determining whether the acquired lightness difference is smaller than a reference value (step S21), setting the ink application amount to be larger than a reference application amount when the lightness difference of the fabric is smaller than the reference value (step S22), and setting the ink application amount to be, for example, a reference application amount A (g/m²) when the lightness difference of the fabric is equal to or larger than the reference value (step S23).

### 1-2-1. Step S21

In step S21, first, the acquired lightness difference is compared with a reference value (a reference value of the lightness difference), and it is determined whether the acquired lightness difference is smaller than the reference value.

The reference value of the lightness difference is not particularly limited, and for example, the lightness difference of a fabric obtained with the use of fibers containing no pigment (pigment-free fibers) can be used as the reference value of the lightness difference. Among these, it is preferable to use, as the reference value of the lightness difference, the lightness difference of a fabric which is obtained with the use of fibers containing no pigment, has an equivalent basis weight, and is obtained by an equivalent weaving method. For example, when the lightness difference of the fabric obtained with the use of the polyester fiber containing no pigment is 21.8, the reference value of the lightness difference can be set to 21.8.

### 1-2-2. Step S22

When the lightness difference of the fabric is smaller than the reference value, the ink application amount is set to an amount (an increase mode) larger than a reference application amount A (g/m²) (step S22). In that case, the ink application amount can be arbitrarily set as long as it is larger than the reference application amount A. For example, the ink application amount may be increased as the lightness difference of the fabric decreases. In particular, when the lightness difference of the fabric is x and the ink application amount is y, it is preferable that they satisfy the following Expression (1) (see FIG. 3A, the filled region).

$$y \geq ( - 0.023 x + 1.5 ) \times A \qquad Expression ( 1 )$$

The reference application amount A is not particularly limited. For example, a standard ink application amount with respect to a fabric obtained with the use of fibers containing no pigment, specifically, an ink amount in which a print density becomes a target density can be set as the reference application amount A. For example, an ink application amount satisfying 30 g/m² in the case of black and 15 g/m² in the case of a color (including white) other than black can be set as the reference application amount A.

However, from the viewpoint of further enhancing the texture of the fabric, it is preferable that the ink application amount is not too large. For example, in Expression (1), the upper limit of the ink application amount y is preferably 100 g/m² or less, more preferably 60 g/m² or less, and still more preferably 40 g/m² or less.

### 1-2-3. Step S23

When the lightness difference of the fabric is equal to or larger than the reference value, for example, the ink application amount can be set to a reference application amount A (g/m²) (standard mode) (step S23, see FIG. 3A). In the present embodiment, when the lightness difference of the fabric is equal to or larger than the reference value, the ink application amount is set to the reference application amount A (see FIG. 3A), but the present invention is not limited thereto, and the ink application amount may be decreased (to be smaller than the reference application amount A) as the lightness difference ΔL* increases (see FIG. 3B).

The ink application amount can be adjusted, for example, by adjusting the amount of ink droplets ejected from the inkjet head. For example, the number of droplets can be increased by the drive waveform (the waveform is designed so that one large droplet is formed by a plurality of small droplets), or the amount of liquid per droplet can be increased by the drive voltage control.

### 1-3. Ink Applying Step (Step S30)

Next, the ink containing a pigment is ejected from the inkjet head at the ink application amount determined in the step S20, thereby applying the ink to the fabric (see FIG. 2). Note that the ink used will be described in detail below.

### 1-4. Other Steps

The image forming method of the present embodiment may further include other steps, when necessary. For example, a step (pretreatment step) of applying a treatment liquid (pretreatment liquid) containing an aggregating agent to a region (of the fabric) to which the ink is to be applied may be performed before the ink applying step, or a step (post-treatment step) of applying a treatment liquid (post-treatment liquid) to a region (of the fabric) to which the ink has been applied may be performed after the ink applying step.

### 1-4-1. Pretreatment Step

A pretreatment liquid containing an aggregating agent may be applied to a region of the fabric to which the ink is to be applied. Thus, the pigment dispersion and the water-dispersible resin in the ink can be easily fixed on the fabric containing the aggregating agent. The pretreatment liquid will be described in detail below.

The method of applying the pretreatment liquid is not particularly limited and may be, for example, a pad method, a coating method, a spraying method, or an inkjet method. Among these, a spraying method or an inkjet method is preferable, and an inkjet method is more preferable, from the viewpoint of enabling higher-speed image formation by carrying out these methods together with a step of applying an ink described below.

The application amount of the pretreatment liquid is not particularly limited, and can be adjusted according to the type of fabric and the application amount of the ink. For example, in the case of a cationic resin, the application amount of the aggregating agent can be set to 0.1 g/m² or more and 1.5 g/m² or less with respect to the fabric. When the pretreatment liquid is applied by an inkjet method, the application amount of the pretreatment liquid is preferably 5.0 g/m² or more and 20.0 g/m² or less. When the pretreatment liquid is applied by a pad method, the pickup rate is preferably 60 to 100%.

### 1-4-2. Post-Treatment Step

A post-treatment liquid may be further applied onto the ink having been applied to the fabric. Thus, the fixability of the pigment to the fabric can be further enhanced, and the friction fastness can be further enhanced. The post-treatment liquid will be described in detail below.

The method of applying the post-treatment liquid is not particularly limited and may be any of a dipping method, a spraying method, and an inkjet method, but is preferably an inkjet method.

The application amount of the post-treatment liquid is not particularly limited, and may be, for example, 5.0 g/m² or more and 20.0 g/m² or less.

### 1-4-3. Drying Step

The fabric to which the ink and, when necessary, the post-treatment liquid have been applied is dried. The drying method is not particularly limited, and the drying may be performed at room temperature or may be performed by heating. The heating method may be a method using a heater, a hot air dryer, a heating roller, or the like, and is preferably a method of heating from both surfaces of the fabric using a hot air dryer and a heater.

The drying temperature is not particularly limited as long as it is a temperature at which the water-soluble organic solvent and water in the ink can be removed, and can be, for example, 80° C. or more and 180° C. or less. The drying time may be, for example, 1 minute or more and 10 minutes or less, depending on the drying temperature.

### 1-5. Effect

As described above, the image forming method of the present embodiment includes a step of applying a pigment-containing ink to a fabric by an inkjet method. Then, when the lightness difference ΔL* of the fabric is smaller than a reference value, the application amount of the ink in the applying step is set to be greater than the reference application amount. As a result, it is possible to form an image with less decrease in color density even on, for example, a fabric obtained with the use of fibers which are difficult to see through.

### 1-6. Modification Example

In step S20 of the above-described embodiment, after the acquired lightness difference is compared with the reference value (step S21), when the lightness difference is smaller than the reference value, the ink application amount is set to be larger than the reference application amount A (step S22), but the step of comparing with the reference value (step S21) may be omitted. For example, in the step S20, the ink application amount may be calculated only by applying the acquired lightness difference into Expression (1). That is, the step of applying the pigment ink to the fabric by an inkjet method may be performed such that the ink application amount y and the lightness difference x of the fabric satisfy Expression (1) without performing the comparison with the reference value.

In addition, in the step S22 of the above-described embodiment, the ink application amount is calculated by applying the acquired lightness difference of the fabric to Expression (1), but the invention is not limited thereto, and the ink application amount may be determined based on data accumulated in advance or the like.

### Second Embodiment

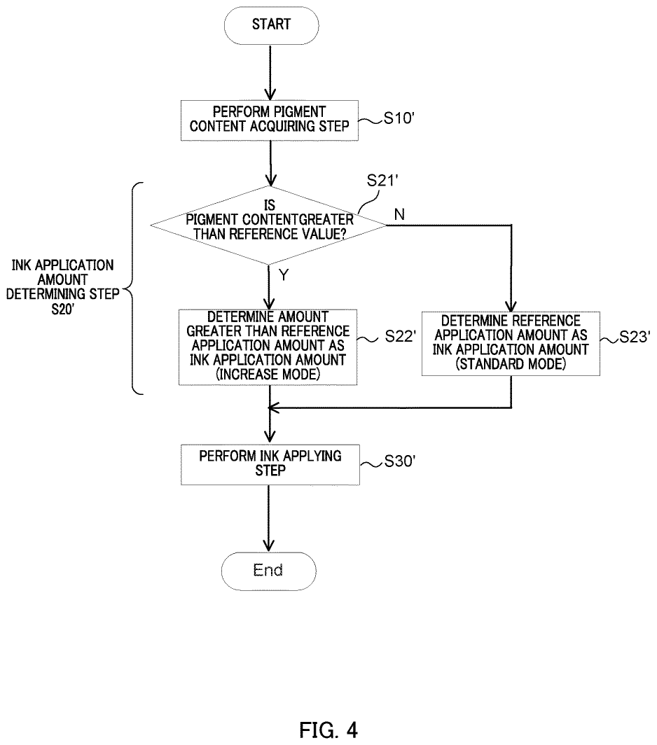

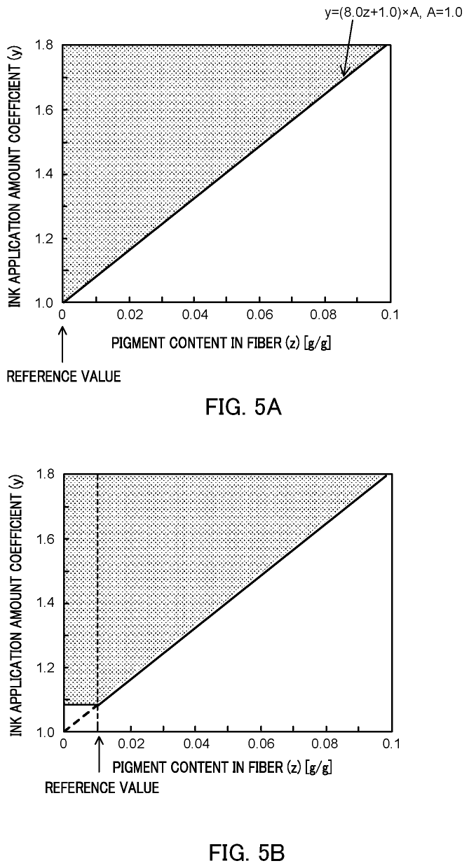

FIG. 4 is a flowchart showing an image forming method according to another embodiment of the present invention. FIGS. 5A and 5B are graphs each illustrating the relationship between the pigment content in fibers and the ink application amount coefficient. The present embodiment is the same as the above-described embodiment except that the ink application amount is adjusted in accordance with the pigment content in the fibers of the fabric instead of the lightness difference of the fabric.

As shown in FIG. 4, the image forming method of present embodiment includes 1) a step of acquiring the pigment content in the fibers of the fabric (acquiring step, step S10′), 2) a step of determining the ink application amount based on the acquired pigment content in the fibers (ink application amount determining step, step S20′), and 3) a step of applying ink to the fabric at the determined ink application amount (ink applying step, step S30′).

### 1-1. Acquiring Step (Step S10′)

In step S10′, the pigment content in the fibers of a fabric is obtained. The pigment content in the fibers of the fabric is expressed as the pigment content (in the fibers) (g) with respect to the total mass (g) of the fibers. The pigment content in the fibers may be acquired by measurement, or data measured in advance may be obtained from another source. The pigment content in the fibers (g/g) can be measured by X-ray fluorescence analysis method.

### 1-2. Ink Application Amount Determining Step (Step S20′)

In Step S20′, the ink application amount is determined based on the acquired pigment content in the fibers. In the present embodiment, the step S20′ includes the steps of determining whether the obtained pigment content in the fibers is more than a reference value (step S21′), setting the ink application amount to be more than a reference application amount when the pigment content in the fibers is more than the reference value (step S22′), and setting, for example, the ink application amount to be the reference application amount when the pigment content in the fibers is equal to or more than the reference value (step S23′).

### 1-2-1. Step S21′

In step S21′, first, it is decided whether or not the acquired pigment content in the fibers is greater than a reference value (a reference value of the pigment content in the fibers). The reference value of the pigment content in the fibers is not particularly limited. For example, the pigment content of a fabric obtained with the use of pigment-free fibers, i.e., 0 (g/g), may be used as the reference value.

### 1-2-2. Step S22′

Subsequently, when the pigment content in the fibers is larger than the reference value, the ink application amount is set to an amount (increase mode) larger than the reference application amount A (g/m²) (step S22′). In that case, the ink application amount can be arbitrarily set as long as it is larger than the reference application amount A. For example, as the pigment content in the fibers increases, the ink application amount may increase. In particular, when the pigment content in the fibers of the fabric is z and the ink application amount is y, they preferably satisfy the following Expression (2) (see the filled region in FIG. 5A).

$$y \geq ( 8. z + 1. ) \times A \qquad Expression ( 2 )$$

The reference application amount A is not particularly limited, but may be the same as the reference application amount A in the above-described embodiment. That is, the ink application amount can be a standard ink application amount with respect to a fabric obtained with the use of fibers containing no pigment.

However, from the viewpoint of further enhancing the texture of the fabric, it is preferable that the ink application amount is not too large. For example, in Expression (2), the upper limit of the ink application amount y is preferably 100 g/m² or less, more preferably 60 g/m² or less, and still more preferably 40 g/m² or less.

### 1-2-3. Step S23′

On the other hand, when the pigment content in the fibers is less than or equal to the reference value, the ink application amount can be used as the reference application amount A (g/m²) (standard mode) (step S23′). Note that although FIG. 5A illustrates the case where the reference value of the pigment content in the fibers is 0 g/g, the present invention is not limited thereto. For example, when the reference value of the pigment content in the fibers is more than 0 g/g (e.g., 0.01 g/g), in a region where the acquired pigment content in the fibers is equal to or less than the reference value, the ink application amount may be constant at the reference application amount (the solid line in FIG. 5B), or may be decreased in accordance with the pigment content (the broken line in FIG. 5B).

### 1-3. Ink Applying Step (S30′)

Next, the pigment-containing ink is applied to the fabric at the ink application amount determined in the step S20′ by an inkjet method.

### 1-4. Effect

As described above, the image forming method of the present embodiment includes a step of applying an ink containing a pigment to a fabric that contains a pigment in fibers thereof by an inkjet method. When the pigment content in the fibers is larger than the reference value, the application amount of the ink in the applying step is set to be greater than the reference application amount. As a result, it is possible to form an image with less decrease in color density even on, for example, a fabric obtained with the use of fibers which are difficult to see through.

### 1-5. Modification Example

In step S20′ of the above-described embodiment, the obtained pigment content in the fibers is compared with the reference value (step S21′), and when the content is larger than the reference value, the ink application amount is set to be larger than the reference application amount A (step S22′). However, the step of comparing with the reference value (step S21′) may be omitted. For example, in step S20′, the ink application amount may only be calculated by applying the acquired pigment content into Expression (2). That is, in the above-described embodiment, the step of applying the pigment ink to the fabric by an inkjet method may be performed such that the ink application amount y and the pigment content z in the fibers of the fabric satisfy Expression (2) without performing the comparison with the reference value.

Furthermore, although the ink application amount is calculated by applying the acquired pigment content in the fibers to Expression (2) in step S22′ of the present embodiment described above, there is no limitation to this and the ink application amount may be determined on the basis of data accumulated in advance or the like. For example, when a fabric containing 0.01 g/g or more of a white pigment in its fibers is used, the ink may be applied at an ink application amount of 18.6 g/m² or more in the step S30′. That is, the following step may be performed: applying a pigment-containing ink by an inkjet method at an ink application amount of 18.6 g/m² or more to a fabric containing, in fibers thereof, 0.01 g/g or more of a white pigment.

### 2. Image Forming Apparatus

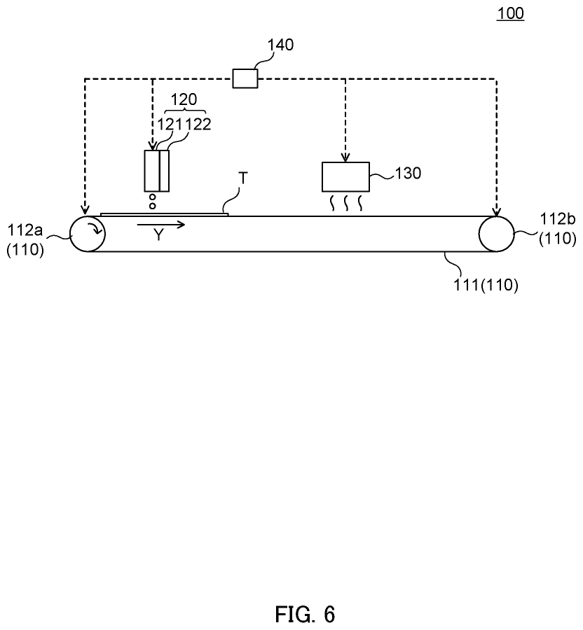

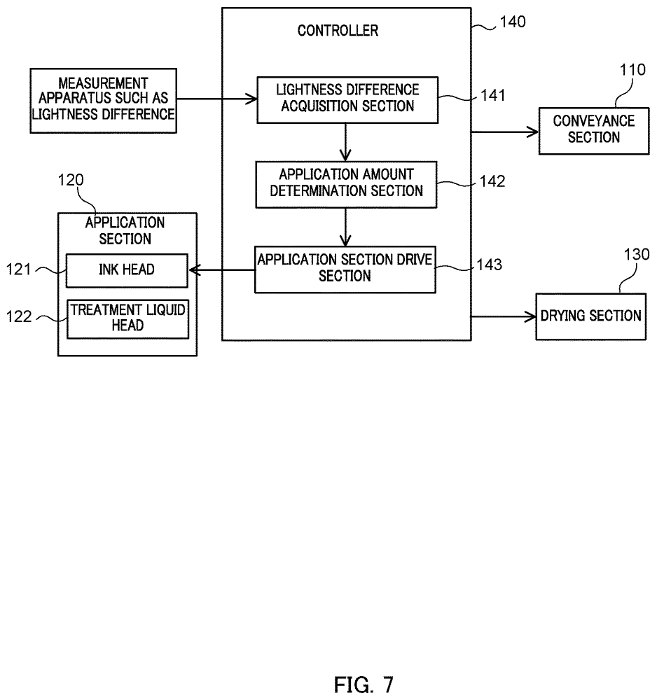

FIG. 6 is a schematic diagram illustrating an image forming apparatus 100 of an embodiment of the present invention. FIG. 7 is a block diagram illustrating a control system of the image forming apparatus 100.

As illustrated in FIG. 6, the image forming apparatus 100 of an embodiment of the present invention includes a conveyance section 110, an application section 120, a drying section 130, and a controller 140.

The conveyance section 110 holds a fabric T and conveys the fabric T to the application section 120 and the drying section 130. In FIG. 6, the conveyance section 110 includes an endless conveyance belt 111 and pulleys 112a and 112b that rotatably support the conveyance belt. Note that the configuration of the conveyance section 110 is not limited to this. For example, the conveyance section 110 may include an unwinding roller, a conveyance roller, and a winding roller, and may be configured to unwind a long fabric wound in a roll shape from the unwinding roller, cause the conveyance roller to convey the fabric, and then cause the winding roller to wind the fabric.

The application section 120 ejects ink from at least an inkjet head. In FIG. 6, the application section 120 includes ink heads 121 (inkjet heads for ink, Y, M, C, and K) to eject ink, a treatment liquid head 122 (inkjet head for treatment liquid, Pr), and a carriage (not illustrated) on which they are mounted. The application section 120 ejects the ink and the treatment liquid from the inkjet head and the treatment liquid head, respectively. Note that the ink head and the treatment liquid head may be housed in the same carriage or in different carriages. In addition, in the case where the treatment liquid is not applied, the application section 120 may include no treatment liquid head.

The drying section 130 is disposed downstream of the application section 120 in the conveyance direction Y, and dries the ink or the treatment liquid applied onto the fabric. The drying section 130 can be a heating means such as a hot air dryer that blows hot air, a heater that irradiates infrared rays or ionizing radiation, or a heating roller.

The controller 140 controls driving of each unit (for example, the conveyance section 110, the application section 120, the drying section 130, and the like) of the image forming apparatus 100, and controls the entire operation. Note that the controller 140 may be implemented, for example, by causing an arithmetic processing unit such as a central processing unit (CPU) to execute a program, that is, by software. Alternatively, the controller 140 may be implemented by hardware such as an integrated circuit (IC). The controller 140 may be implemented by a combination of software and hardware.

The controller 140 includes a lightness difference and the like acquisition section (herein simply referred to as “lightness difference acquisition section”) 141, an application amount determination section 142, and an application section drive section 143 (see FIG. 7).

The lightness difference acquisition section 141 performs the above-described step S10 or S10′. That is, the lightness difference acquisition section 141 acquires information on the fabric such as the lightness difference of the fabric and the pigment content in fibers (also referred to as “lightness difference and the like”). The lightness difference acquisition section 141 may be any means capable of acquiring the lightness difference of the fabric and the pigment content in the fibers measured by the measurement device or an external device. For example, information such as the lightness difference of the fabric and the pigment content in the fibers may be input by a user operating an operation section (not illustrated), or may be input from an external measurement device. The information relating to the fabric may include not only the lightness difference and the pigment content in fibers, but also the type (material) of the fiber of the fabric, the ratio of the chemical fiber, and the like.

The application amount determination section 142 performs the above-described step S20 (S21 to S23) or S20′ (S21′ to S23′) based on the acquired lightness difference and the like. In the present embodiment, it is decided whether the lightness difference acquired by the lightness difference acquisition section 141 is smaller than a reference value, and it is decided whether the pigment content in the fibers is higher than a reference value. Then, when the acquired lightness difference is smaller than a reference value or the acquired pigment content in the fibers is greater than a reference value, the ink application amount is calculated and determined using Expression (1), Expression (2), or the like such that the ink application amount becomes greater than the reference application amount. On the other hand, when the acquired lightness difference is equal to or larger than the reference value, or when the acquired pigment content in the fibers is equal to or smaller than the reference value, for example, the ink application amount is determined as the reference application amount. Note that various types of data such as the reference value of the lightness difference, the reference value of the pigment content, the reference application amount A, Expression (1), Expression (2), and the data of the ink application amount are stored in a storage section (not illustrated) such as the ROM.

As described above, when the acquired lightness difference is equal to or larger than the reference value or when the acquired pigment content in fibers is equal to or smaller than the reference value, the ink application amount may be determined so that the ink application amount becomes smaller than the reference application amount.

The application section drive section 143 performs the above-described step S30 or S30′. Specifically, the application section drive section 143 drives the ink head 121 of the application section 120 to attain the ink application amount calculated by the application amount determination section 142. Specifically, the application section drive section 143 adjusts the amount of droplets to be ejected from the ink head 121 and the driving voltage so as to achieve the ink application amount determined by the application amount determination section 142.

### (Operation)

In the image forming apparatus 100 configured in such a manner, the following operation is performed under the control of the controller 140 (see FIG. 6).

That is, the fabric T is conveyed to the application section 120 by the conveyance section 110. Ink is applied onto the fabric conveyed to the application section 120 from an ink head 121 of the application section 120. The fabric T on which the ink has been applied is conveyed to the drying section 130 by the conveyance section 110, and is dried, thereby obtaining an image formed product.

Here, during the application of the ink by the application section 120, the above steps S10 to S30 (or steps S10′ to S30′) are executed by the controller 140. That is, the lightness difference acquisition section 141 acquires, for example, information on a fabric input by the user (lightness difference, pigment content in fibers, and the like). The application amount determination section 142 determines the ink application amount based on the acquired information. The application section drive section 143 drives the ink head 121 of the application section 120 so as to attain the determined ink application amount. For example, the inkjet head is controlled to adjust the ink application amount to the fabric so as to attain the determined ink application amount.

### (Effect)

As described above, in the image forming apparatus of the present embodiment, the controller 140 controls the inkjet head so that the ink application amount corresponds to the lightness difference of the fabric or the pigment content in fibers. Specifically, when the lightness difference is smaller than a reference value or the pigment content in the fibers is larger than a reference value, the controller 140 controls the inkjet head such that the ink application amount to the fabric becomes larger than a reference application amount. Thus, for example, an image with less decrease in color density can be formed even on a fabric obtained with the use of fibers that are difficult to see through.

### Modification Example

The application amount determination section 142 of the present embodiment calculates the ink application amount by comparing the acquired lightness difference of the fabric or the pigment content in the fibers with reference values and then applying the lightness difference of the fabric to Expression (1) or the pigment content in the fibers to Expression (2), but the step of comparing with the reference value may be omitted. For example, the application amount determination section 142 may simply calculate the ink application amount by directly applying the acquired lightness difference into Expression (1) or directly applying the acquired pigment content in the fibers into Expression (2). That is, the controller 140 may control the inkjet head such that the lightness difference of the fabric and the ink application amount satisfy Expression (1) or the pigment content in the fibers and the ink application amount satisfy Expression (2). Alternatively, the controller 140 may control the inkjet head to attain a preset ink application amount in accordance with the lightness difference of the fabric or the pigment content in the fibers.

### 3. Ink and Treatment Liquid

Next, the ink, the pretreatment liquid, and the post-treatment liquid that can be used in the image forming method will be described.

### 3-1. Ink

The ink is a water-based ink and includes a pigment, an anionic water-dispersible resin, and a water-based solvent.

### (Pigment)

The pigment is not particularly limited, and examples thereof include organic pigments or inorganic pigments having the following numbers described in the Color Index.

Examples of red or magenta pigments include Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50, 88, Pigment Orange 13, 16, 20, 36.

Examples of blue or cyan pigments include Pigment Blue 1, 15, 15:1, 15:2, 15:3, 15:4, 15:6, 16, 17-1, 22, 27, 28, 29, 36, 60.

Examples of green pigments include Pigment Green 7, 26, 36, and 50.

Examples of yellow pigments include Pigment Yellow 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193.

Examples of black pigments include Pigment Black 7, 28, and 26.

Examples of commercially available pigments include Chrome Fine Yellow 2080, 5900, 5930, AF-1300, 2700L, Chrome Fine Orange 3700L, 6730, Chrome Fine Scarlet 6750, Chrome Fine Magenta 6880, 6886, 6891N, 6790, 6887, Chrome Fine Violet RE, Chrome Fine Red 6820, 6830, Chrome Fine Blue HS-3, 5187, 5108, 5197, 5085N, SR-5020, 5026, 5050, 4920, 4927, 4937, 4824, 4933GN-EP, 4940, 4973, 5205, 5208, 5214, 5221, 5000P, Chromofine Green 2GN, 2GO, 2G-550D, 5310, 5370, 6830, Chromofine Black A-1103, Seikafast Yellow 10GH, A-3, 2035, 2054, 2200, 2270, 2300, 2400 (B), 2500, 2600, ZAY-260, 2700 (B), 2770, Seikafast Red 8040, C405 (F), CA120, LR-116, 1531B, 8060R, 1547, ZAW-262, 1537B, GY, 4R-4016, 3820, 3891, ZA-215, Seikafast Carmine 6B1476T-7, 1483LT, 3840, 3870, Seikafast Bordeaux 10B-430, Seikalite Rose R40, Seikalite Violet B800, 7805, Seikafast Maroon 460N, Seikafast Orange 900, 2900, Seikalite Blue C718, A612, Cyanine Blue 4933M, 4933GN-EP, 4940, 4973 (manufactured by Dainichiseika Color & Chemicals Mfg. Co., Ltd.); KET Yellow 401, 402, 403, 404, 405, 406, 416, 424, KET Orange 501, KET Red 301, 302, 303, 304, 305, 306, 307, 308, 309, 310, 336, 337, 338, 346, KET Blue 101, 102, 103, 104, 105, 106, 111, 118, 124, KET Green 201 (manufactured by Dainippon Ink and Chemicals Co., Ltd.); Colortex Yellow 301, 314, 315, 316, P-624, 314, U10GN, U3GN, UNN, UA-414, U263, Finecol Yellow T-13, T-05, Pigment Yellow1705, Colortex Orange 202, Colortex Red101, 103, 115, 116, D3B, P-625, 102, H-1024, 105C, UFN, UCN, UBN, U3BN, URN, UGN, UG276, U456, U457, 105C, USN, Colortex Maroon601, Colortex BrownB610N, Colortex Violet600, Pigment Red 122, Colortex Blue 516, 517, 518, 519, A818, P-908, 510, Colortex Green402, 403, Colortex Black 702, U905 (manufactured by Sanyo Shiki Co., Ltd.); Lionol Yellow 1405G, Lionol Blue FG7330, FG7350, FG7400G, FG7405G, ES, ESP-S (manufactured by Toyo Ink Co., Ltd.), Toner Magenta E02, Permanent Rubin F6B, Toner Yellow HG, Permanent Yellow GG-02, Hostapeam Blue B2G (manufactured by Hoechst AG); Novoperm P-HG, Hostaperm Pink E, Hostaperm Blue B2G (manufactured by Clariant); and BlueB2G (manufactured by Hoechst Industri); Novoperm P-HG, Hostaperm Pink E, Hostaperm Blue B2G (manufactured by Clariant); carbon black #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, CF9 (manufactured by Mitsubishi Chemical Corporation).

### (Self-Dispersible Pigment)

The pigment may be a self-dispersible pigment. The self-dispersible pigment is obtained by modifying the surface of a pigment particle with a group having a hydrophilic group. The self-dispersible pigment includes a pigment particle and a hydrophilic group bonded to the surface of the pigment particle.

Examples of the hydrophilic group include carboxyl group, sulfonic acid group, and phosphorus-containing group. Examples of the phosphorus-containing group include phosphoric acid group, phosphonic acid group, phosphinic acid group, phosphite group, and phosphate group.

Examples of commercially available self-dispersible pigments include Cab-0-Jet (registered trademark) 200K, 250C, 260M, and 270 V (sulfonic acid group-containing self-dispersible pigments) manufactured by Cabot Corporation. Other examples of commercially available self-dispersible pigments include Cab-0-Jet (registered trademark) 300K (carboxylic acid group-containing self-dispersible pigments) and Cab-0-Jet (registered trademark) 400K, 450C, 465M, 470 V, and 480 V (phosphoric acid group-containing self-dispersible pigments) available from Cabot Corporation.

The content of the pigment is not particularly limited, but is preferably in a range of 1.5% by mass or more and 15% by mass or less with respect to the ink. When the content of the pigment is 1.5% by mass or more, a high-density image is easily formed. When the content of the pigment is 15% by mass or less, the viscosity of the ink does not become excessively high, and thus the ejection stability is less likely to be impaired. For the same reason, the content of the pigment is more preferably 5% by mass or more and 15% by mass or less with respect to the ink.

### (Water-Based Solvent)

The water-based solvent contains water, and preferably further contains a water-soluble organic solvent. By further including a water-soluble organic solvent, it is possible to further increase the ejection stability by an inkjet method.

The water-soluble organic solvent is not particularly limited as long as it is compatible with water. Examples of the water-soluble organic solvents include polyhydric alcohols (e.g., dihydric alcohols such as ethyleneglycol, diethyleneglycol, triethyleneglycol, polyethyleneglycol, propyleneglycol, dipropyleneglycol, tripropyleneglycol and polypropyleneglycol, and trihydric or higher alcohols such as glycerol, trimethylolpropane and hexanetriol); polyhydric alcohol ethers (e.g., ethyleneglycol monomethylether, ethyleneglycol monoethylether, ethyleneglycol monobutylether, ethyleneglycol monophenylether, diethyleneglycol monomethylether, diethyleneglycol monoethylether, diethyleneglycol monobutylether, diethyleneglycol dimethylether, propyleneglycol monomethylether and propyleneglycol monoethylether); monohydric alcohols (e.g., methanol, ethanol, propanol, pentanol, hexanol, cyclohexanol and benzylalcohol); amines (e.g., ethanol amine, N-ethyldiethanolamine, morpholine, N-ethylmorpholine, ethylene diamine, diethylene diamine and triethylene tetramine); amides (e.g., formaldehyde, N,N-dimethylformamide and N,N-dimethylacetamide); heterocycles (e.g., 2-pyrrolidone, N-methyl-2-pyrrolidone, N-cyclohexyl-2-pyrrolidone, 2-oxazolidone and 1,3-dimethyl-2-imidazolidine); sulfoxides (e.g., dimethylsulfoxide); and sulfones (e.g., sulfolane).

In addition, from the viewpoint of further enhancing ejection stability by an inkjet method, the water-soluble organic solvent preferably includes a water-soluble organic solvent having a boiling point of 180° C. or more, preferably 190° C. or more, and more preferably 200° C. or more. Examples of the water-soluble organic solvent having a boiling point of 180° C. or higher include dihydric alcohols and trihydric or higher alcohols. Examples of the dihydric alcohols include ethylene glycol (boiling point: 197° C.), 1,3-butanediol (boiling point: 208° C.), 1,6-hexanediol (boiling point: 223° C.), and polypropylene glycol. Examples of trihydric or higher alcohols include glycerin (boiling point: 290° C.) and trimethylolpropane (boiling point: 295° C.).

The content of the water-soluble organic solvent in the ink is, for example, preferably 20% by mass or more and 70% by mass or less, more preferably 30% by mass or more and 60% by mass or less with respect to the ink.

Similarly, the content of the water in the ink is, for example, preferably 20% by mass or more and 70% by mass or less, more preferably 30% by mass or more and 60% by mass or less with respect to the ink.

### (Other Components)

The ink may further contain a component other than those described above, when necessary. Examples of other components include a water-dispersible resin and various additives.

### (Water-Dispersible Resin)

In viewpoint of further enhancing the fixability of the pigment to fabric, the ink preferably further includes a water-dispersible resin. Such a water-dispersible resin is contained as resin particles in the ink, and can have a function of further increasing the fixability of the pigment or the like to the fabric. The water-dispersible resin is preferably an anionic water-dispersible resin containing an anionic functional group. Examples of the anionic functional group include hydroxyl group, carboxyl group, and sulfonic acid group.

Examples of the anionic water-dispersible resin include resins such as anionic urethane resins, butadiene resins, (meth)acrylic resins, and polystyrene. Among these, anionic urethane resins and anionic (meth)acrylic resins are preferable.

Examples of the anionic (meth)acrylic resin include (meth)acrylic acid ester copolymers, styrene-(meth)acrylic copolymers, silicone-(meth)acrylic copolymers, and acrylic-modified fluororesins, each of which contains a constitutional unit derived from (meth)acrylic acid, styrene sulfonic acid, hydroxystyrene, or the like.

Examples of the anionic styrene-(meth)acrylic copolymer include a styrene-(meth)acrylic acid copolymer and a styrene-(meth)acrylic acid-(meth)acrylic acid ester copolymer, which include a constitutional unit derived from (meth)acrylic acid, styrenesulfonic acid, hydroxystyrene, or the like. Examples of the (meth)acrylic acid ester include benzyl (meth)acrylate, cyclohexyl (meth)acrylate, methyl (meth)acrylate, ethyl (meth)acrylate, propyl (meth)acrylate, butyl (meth)acrylate, hexyl (meth)acrylate, octyl (meth)acrylate, lauryl (meth)acrylate, 2-ethylhexyl (meth)acrylate, 2-ethylhexylcarbitol (meth)acrylate, phenol EO-modified (meth)acrylate, isobornyl (meth)acrylate, dicyclopentenyl (meth)acrylate, dicyclopentanyl (meth)acrylate, dicyclopentenyloxyethyl (meth)acrylate and the like.

The anionic urethane resin is a polymer obtained by reacting a polyol and a polyisocyanate, and contains a carboxyl group, a sulfonic acid group, and the like in a part or all of the polyol and the polyisocyanate. Examples of polyols include polypropylene glycol, polyethylene glycol, polytetramethylene glycol, poly(ethylene adipate), poly(diethylene adipate), poly(propylene adipate), poly(tetramethylene adipate), poly(hexamethylene adipate), poly-ε-caprolactone, poly(hexamethylene carbonate), silicone polyols, and the like. Examples of isocyanates include tolylene diisocyanate, 4,4-diphenylmethane diisocyanate, xylylene diisocyanate, naphthalene diisocyanate, hexamethylene diisocyanate, hydrogenated tolylene diisocyanate, hydrogenated 4,4-diphenylmethane diisocyanate, isophorone diisocyanate, tetramethylxylylene diisocyanate, and the like.

The Tg of the water-dispersible resin is not particularly limited, but is preferably low from the viewpoint that the fabric is less likely to become hard even after image formation and the texture is easily maintained. The Tg of the anionic water-dispersible resin can be, for example, −30° C. or more and 100° C. or less, preferably −10° C. or more and 50° C. or less.

The acid value of the water-dispersible resin is not particularly limited, but is preferably 44 mgKOH/g or more, and more preferably 60 mgKOH/g or more, for example, from the viewpoint of enhancing dispersion stability. The upper limit value of the acid value may be, for example, 110 mgKOH/g. The acid value can be measured in accordance with the measurement method of JIS K0070:1992.

The average particle size of the water-dispersible resins is not particularly limited, but is preferably 300 nm or smaller, and more preferably 130 nm or smaller, from the viewpoint of making nozzle clogging of an inkjet head less likely to occur. The average particle size of the anionic water-dispersible resin can be measured by laser diffraction scattering particle size distribution measurement.

The content of the water-dispersible resin is preferably 1% by mass or more and 15% by mass or less with respect to the ink. When the content of the anionic water-dispersible resin is 1% by mass or more, the viscosity of the ink is more likely to be moderately increased, and thus not only the ejection stability can be further increased, but also the adhesiveness of the obtained image to a fabric and the abrasion resistance are more likely to be increased. When the content of the water-dispersible resin is 15% by mass or less, the viscosity of the pigment ink does not become excessively high, and thus nozzle clogging or the like is less likely to occur. For the same reason, the content of the anionic water-dispersible resin is more preferably 2% by mass or more and 10% by mass or less with respect to the ink.

### (Additive)

The ink may further contain various additives such as a surfactant, a preservative, and an antifungal agent as needed.

The surfactant can lower the surface tension of the ink and increase the wettability of the ink to the fabric. The type of surfactant is not particularly limited, and may be, for example, an acetylene glycol-based surfactant, a silicone-based surfactant, or a fluorine-based surfactant.

Examples of the preservative or antifungal agent include aromatic halogen compounds (e.g., Preventol CMK), methylene dithiocyanate, halogen-containing nitrogen-sulfur compounds, 1,2-benzisothiazolin-3-one (e.g., PROXEL GXL), and the like.

### 3-2. Pretreatment Liquid

### (Aggregating Agent)

The aggregating agent aggregates the pigment dispersion and the water-dispersible resin in the ink. Since the pigment dispersion and the water-dispersible resin have an anionic group, the aggregating agent is preferably a cationic aggregating agent. The aggregation using a cationic aggregating agent may utilize a change in pH or an electrical effect.

Examples of the aggregating agent that causes aggregation by a change in pH include organic acids. Examples of the organic acid include carboxylic acids having 6 or less carbon atoms, such as saturated fatty acids (e.g., formic acid, acetic acid, propionic acid, butyric acid, valeric acid, and hexanoic acid) and hydroxy acids (e.g., lactic acid, malic acid, and citric acid).

Examples of the aggregating agent that causes aggregation by an electrical effect include compounds having a cationic group and metal salts.

Examples of the cationic group in the compound having a cationic group include secondary amino groups, tertiary amino groups, and quaternary ammonium salt groups. Examples of the compound having a cationic group include cationic resins and cationic surfactants, and cationic resins are preferable.

The cationic resin is preferably a water-soluble cationic resin. Examples of the water-soluble cationic resin include cationic urethane resins, cationic olefin resins, and cationic alkylamine resins (e.g., quaternary salts of alkylamine/epichlorohydrin adducts). Examples of commercially available products include MPT-60 (manufactured by Mitsubishi Pencil Co., Ltd), Unisence KHE-100 L (manufactured by Senka Corporation), and MZ477 (urethane resin manufactured by Takamatsu Oil & Fat Co., Ltd). Among these, UNISENCE KHE100L (manufactured by Senka Corporation) is preferable.

The metal salt is preferably a polyvalent metal salt. The polyvalent metal salt may be a water-soluble compound having a divalent or more polyvalent metal ion and an anion to be bonded thereto. Examples of the polyvalent metal ion include divalent metal ions such as Ca²⁺, Cu²⁺, Ni²⁺, Mg²⁺, Zn²⁺, and Ba²⁺; and a trivalent metal ion such as Al³⁺, Fe³⁺, and Cr³⁺. Examples of the anion include Cl⁻, I⁻, Br⁻, SO₄²⁻, ClO³⁻, NO³⁻, HCOO⁻, and CH₃COO⁻. Examples of such polyvalent metal salts include zinc acetate dihydrate, magnesium nitrate, calcium chloride, magnesium chloride, aluminum chloride, magnesium sulfate, and metal salts of organic acids such as calcium, magnesium, nickel, and aluminum salts of acetic acid and other organic acids. Among these, calcium salts and magnesium salts are preferable, and calcium nitrate and calcium chloride are preferable.

As described above, the aggregating agent preferably includes at least one or more of an organic acid, a metal salt, and a water-soluble cationic resin, and more preferably includes a water-soluble cationic resin. In particular, a fabric treated with a pretreatment liquid containing a cationic resin is more likely to aggregate the pigment dispersion than a fabric treated with a polyvalent metal salt or a fabric treated with an organic acid.

The cation value of the cationic resin is preferably 0.5 mmol/g or more and 10.0 mmol/g or less, and more preferably 1.2 mmol/g or more and 6.2 mmol/g or less. When the cation value is 0.5 mmol/g or more, the aggregation reaction proceeds more easily, and the friction fastness can be further enhanced. When the cation value is 10.0 mmol/g or less, an excessive aggregation reaction is less likely to proceed.

The cation value of the cationic resin is a value measured by the following colloidal titration method.
(1) An aqueous dispersion liquid of a resin is prepared.
(2) Toluidine blue is added as an indicator.
(3) Titration is performed using PVSK (Potassium polyvinyl sulfate) solution as the titrant. The titration ends when the color of the dispersion liquid changes from blue to red.
(4) The cation value is calculated from the resin amount (solid content) in the aqueous dispersion liquid and the titration amount of the PVSK solution.

The content of the aggregating agent is preferably from 1.0% by mass to 20% by mass, and more preferably from 2.0% by mass to 10% by mass, with respect to the pretreatment liquid. When the content is 2.0% by mass or more, the aggregation of the pigment dispersion can be further promoted. In addition, when the content of the cationic aggregating agent is 10% by mass or less, it is possible to further prevent the texture from being deteriorated.

### (Water-Based Solvent)

The water-based solvent contains water, and preferably further contains a water-soluble organic solvent.

The water content in the pretreatment liquid is, for example, preferably 20% by mass or more and 70% by mass or less and more preferably 30% by mass or more and 60% by mass or less with respect to the pretreatment liquid. The content of the water-soluble organic solvent in the pretreatment liquid is, for example, preferably 20% by mass or more and 70% by mass or less and more preferably 30% by mass or more and 60% by mass or less with respect to the pretreatment liquid.

### (Other Components)

The pretreatment liquid may further contain a component other than those described above, when necessary. As the other components, the same other additives as those used in the ink can be used.

### 3-3. Post-Treatment Liquid

The post-treatment liquid includes a water-dispersible resin and an water-based solvent.

### (Water-Dispersible Resin)

The water-dispersible resin may be the same as the water-dispersible resin or the like used in the ink. That is, the water-dispersible resin preferably contains an anionic water-dispersible resin.

The content of the water-dispersible resins is preferably 1.0% by mass or more and 20% by mass or less and more, preferably 3.0% by mass or more and 10% by mass or less, with respect to the post-treatment liquid. When the content is 1.0% by mass or more, the fixability of the pigment to fabric can be further enhanced, and the friction fastness can be further enhanced. In addition, when the content of the water-dispersible resin is 20% by mass or less, deterioration of the texture is less likely to occur.

### (Water-Based Solvent)

The content of the water-soluble organic solvent in the post-treatment liquid is, for example, preferably 10% by mass or more and 65% by mass or less and more preferably 20% by mass or more and 45% by mass or less with respect to the post-treatment liquid. Similarly, the content of water in the post-treatment liquid is, for example, preferably 30% by mass or more and 85% by mass or less and more preferably 50% by mass or more and 75% by mass or less with respect to the post-treatment liquid.

### (Other Components)

The post-treatment liquid may further contain other components than the above-described components, when necessary. As the other components, the same various additives as those used in the ink can be used.

### EXAMPLE

Hereinafter, the present invention will be specifically described with reference to Examples, but the present invention is not limited thereto.

### 1. Preparation of Ink

### 1-1. Preparation of Pigment Dispersion Liquid

### (Preparation of Black Pigment Dispersion Liquid)

A neutralized product of a pigment dispersing agent was prepared by mixing 7 parts by mass of a styrene-butyl acrylate-methacrylic acid-copolymer (anionic-dispersing agent, weight-average molecular weight: 16000, anionic-group equivalence: 3.5 meq/g) as a pigment dispersing agent with 63 parts by mass of water, then heating with stirring, and adding sodium hydroxide in an amount corresponding to a neutralization degree of 50%. To the mixed liquid, 30 parts by mass of carbon black was added and premixed, and then dispersed by using a sand grinder filled with 50% by volume of 0.5 mm zirconia beads to obtain a black pigment dispersion liquid having a pigment concentration of 30% by mass.

### (Preparation of Cyan Pigment Dispersion Liquid)

A cyan pigment dispersion liquid having a pigment concentration of 30% by mass was obtained in the same manner as above except that the carbon black was changed to the cyan pigment.

### 1-2. Preparation of Ink

### (Preparation of Ink 1)

After mixing 20 parts by mass of propyleneglycol and 10 parts by mass of glycerin as solvents, 0.1 part of Olfine E1010 (manufactured by Nissin Chemical Industry Co., Ltd., surfactant) as a surfactant, 0.05 parts by mass of Proxel GXL(S) as a preservative and 29.85 parts by mass of ion-exchanged water, 30 parts by mass of Takelac W 6061 as an anionic resin and 9 parts by mass of the black pigment dispersion liquid were mixed. The pH of the mixed liquid was adjusted to 9.0 with a 20% potassium bicarbonate aqueous solution to obtain black ink.

### (Preparation of Ink 2)

A cyan ink was obtained in the same manner as the ink 1 except that the black pigment dispersion liquid was changed to the cyan pigment dispersion liquid.

### 2 Preparation of Treatment Liquid

### 2-1. Preparation of Pretreatment Liquid

Twenty (20) parts by mass of propyleneglycol and 10 parts by mass of glycerin as solvents, 0.1 parts by mass of surfynol E1010 as a surfactant, 0.05 parts by mass of Proxel GXL(S) as a preservative, 2 parts by mass of a quaternary salt of an alkylamine/epichlorohydrin adduct as a cationic resin, and 67.85 parts by mass of ion-exchanged water were mixed to obtain a pretreatment liquid.

### 2-2. Preparation of Post-Treatment Liquid

Twenty (20) parts by mass of propyleneglycol and 10 parts by mass of glycerin as solvents, 0.1 part by mass of Olfine E1010 as a surfactant, 0.05 part by mass of Proxel GXL(S) as a preservative, and 43.85 parts by mass of ion-exchanged water were mixed, followed by mixing with 25 parts by mass of Takelac W 6061 as an anionic resin. The pH of the mixed liquid was adjusted to 9.0 with a 20% by mass aqueous potassium bicarbonate solution to obtain a post-treatment liquid.

### 3. Fabric Preparation

Fabrics of the following Table 1 were prepared.

TABLE 1

| | | | | L* [—] | L*[—] | |
|---|---|---|---|---|---|---|
| | | Contained | Con- | on | on | Lightness |
| Fabric | | color | tent | black | white | difference |
| type | Fibers | material | [g/g] | trap | plate | [—] |
| Fabric A | Polyester | Titanium | 0.000 | 76.7 | 98.5 | 21.8 |
| | | oxide | | | | |
| Fabric B | Polyester | Titanium | 0.010 | 79.5 | 98.7 | 19.3 |
| | | oxide | | | | |
| Fabric C | Polyester | Titanium | 0.015 | 81.1 | 98.5 | 17.4 |
| | | oxide | | | | |
| Fabric D | Polyester | Titanium | 0.030 | 87.5 | 97.9 | 10.4 |
| | | oxide | | | | |

(Measurement of lightness difference ΔL*)

The lightness difference (ΔL*) of the fabric to be calculated by the following expression was measured with a spectrophotometer (e.g., CM-Konica 25d manufactured by Konica Minolta, Inc) under the conditions of light sources D65/10° and field of view/SCI.

$$The lightness difference Δ {L}^{*} = ( lightness {L}^{*} measured in a state where the fabric is disposed on a standard white plate ) - ( lightness {L}^{*} measured in a state where the fabric is disposed on a standard black plate )$$

Note that a standard white plate of a commonly used calibration stand was used as the standard white plate, and a black trap of the commonly used calibration stand was used as the standard black plate.

### (Pigment Content in Fiber)

The pigment content in the fibers in Table 1 is a value measured by an X-ray fluorescence analysis method.

### 4. Image Formation

### [Test 1]

The ink 1, the pretreatment liquid, and the post-treatment liquid produced above were set in a simple image printing tester equipped with KM1024i heads as inkjet heads.

Then, the ink was ejected from the inkjet head of the simple image printing tester to apply the ink onto the surface of the fabric of Table 2 (ink applying step).

Next, the prepared post-treatment liquid was ejected from an inkjet head to the ink-applied region of the fabric to apply the post-treatment liquid. The application amount of the treatment liquid was 15 g/m² (post-treatment step).

The ink and the post-treatment liquid were both applied by a multi-pass method in main scanning 540 dpi×sub-scanning 720 dpi. Here, “dpi” stands for number of ink droplets (dots) per 2.54 cm. The ejection frequency was set to 22.4 kHz. The image to be formed was an image including a fine line grid, gradation, and a solid portion (200 mm×200 mm as a whole).

Thereafter, the fabric was dried at 150° C. for 3 minutes by a belt conveying type dryer to obtain an image formed product.

### [Evaluation]

### (Measurement of Concentration)

The density of the formed solid image was measured using a spectrophotometer (manufactured by Konica Minolta, Inc), and evaluated as follows. Note that the fabric A is used as a reference fabric.
A: density equal to or higher than that of the reference fabric
B: density equivalent to the reference fabric
C: not reaching the same density as the reference fabric

### (Texture)

The bending strength B-MEAN [gf* cm²/cm] was measured using a KES-Kato-A pure bending tester (manufactured by FB2 Tech Co., Ltd), and the difference ΔB from the untreated fabric was calculated and evaluated as follows. The width of the fabric was set to 20 cm.

$$Δ B \leq 0.12 \qquad A$$

$$0.12 < Δ B \leq 0.2 \qquad B$$

$$0.2 < Δ B \qquad C$$

The evaluation results of Tests 1-1 to 1-6 are shown in Table 2.

In this test, the lightness difference (21.6) of the fabric A containing no pigment in the fibers thereof is defined as a “reference value of lightness difference”, and the pigment content (0 g/g) in the fibers is defined as a “reference value of pigment content in the fibers”. The same applies to the following tests.

TABLE 2

| | | | | | | y calculated | y calculated | | | |
|---|---|---|---|---|---|---|---|---|---|---|
| | | | | Reference | Ink | from | from | | | |
| | | Lightness | | application | application | Expression | Expression | | | |
| Test | Fabric | difference | Presence of | amount A | amount y | (1) | (2) | y/A | | |
| No. | type | [—] | pretreatment? | [g/m²] | [g/m²] | [g/m²] | [g/m²] | [—] | Density | Texture |
| 1-1 | Fabric A | Reference | No | 30.0 | 30.0 | — | — | 1.0 | B | A |
| | | value | | | | | | | | |
| 1-2 | Fabric B | 19.3 | No | 30.0 | 30.0 | 31.7 | 32.4 | 1.0 | C | A |
| 1-3 | Fabric B | 19.3 | No | 30.0 | 33.0 | | | 1.1 | B | A |
| 1-4 | Fabric B | 19.3 | No | 30.0 | 39.0 | | | 1.3 | B | A |
| 1-5 | Fabric B | 19.3 | No | 30.0 | 45.0 | | | 1.5 | A | B |
| 1-6 | Fabric B | 19.3 | No | 30.0 | 60.0 | | | 2.0 | A | B |

### [Test 2]

Before the application of the ink 1, the pretreatment liquid was applied to the surface of the fabric in Table 3 by ejecting the pretreatment liquid from an inkjet head of the simple image printing tester. The application amount of the pretreatment liquid was 12 g/m² (pretreatment liquid applying step).

Next, an image was formed in the same manner as in Test 1 except that the ink 1 and the post-treatment liquid were applied as follows: the ink 1 and the post-treatment liquid produced above were ejected sequentially from inkjet heads onto the region of the fabric (the region where the pretreatment liquid was applied). The same evaluation was then performed.

Table 3 shows the evaluation results of Tests 2-1 to 2-6. Note that the lightness difference of the pretreated fabric A was the same as the lightness difference of the fabric A without pretreatment.

TABLE 3

| | | | | | | y calculated | y calculated | | | |
|---|---|---|---|---|---|---|---|---|---|---|
| | | | | Reference | Ink | from | from | | | |
| | | Lightness | | application | application | Expression | Expression | | | |
| Test | Fabric | difference | Presence of | amount A | amount y | (1) | (2) | y/A | | |
| No. | type | [—] | pretreatment? | [g/m²] | [g/m²] | [g/m²] | [g/m²] | [—] | Density | Texture |
| 2-1 | Fabric A | Reference | Yes | 30.0 | 30.0 | — | — | 1.0 | A | A |
| | | value | | | | | | | | |
| 2-2 | Fabric B | 19.3 | Yes | 30.0 | 30.0 | 31.7 | 32.4 | 1.0 | C | A |
| 2-3 | Fabric B | 19.3 | Yes | 30.0 | 33.0 | | | 1.1 | A | A |
| 2-4 | Fabric B | 19.3 | Yes | 30.0 | 39.0 | | | 1.3 | A | A |
| 2-5 | Fabric B | 19.3 | Yes | 30.0 | 45.0 | | | 1.5 | A | B |
| 2-6 | Fabric B | 19.3 | Yes | 30.0 | 60.0 | | | 2.0 | A | B |

### [Discussion]

As shown in Tables 2 and 3, it was confirmed that when the reference application amount of ink was applied to the fabric A (fabric containing no pigment in fibers thereof), sufficient density was achieved (see Test 1-1 and 2-1).

Whereas, it was confirmed that when the reference application amount of ink was applied to the fabric B (fabric containing a pigment in fibers thereof) (refer to Test 1-2 and 2-2), the density became insufficient.

On the other hand, it was confirmed that when the ink was applied onto the fabric B at an amount larger than the reference application amount, a sufficient density was obtained (see Tests 1-2 to 1-6 and 2-2 to 2-6).

### [Test 3]

An image was formed in the same manner as in Test 2 except that the pretreatment liquid, the ink 1, and the post-treatment liquid prepared above were applied onto the fabric C by sequentially ejecting the pretreatment liquid, the ink 1, and the post-treatment liquid from the inkjet heads, and the same evaluation was performed.

Table 4 shows the evaluation results of Tests 3-1 to 3-5.

TABLE 4

| | | | | | | y calculated | y calculated | | | |
|---|---|---|---|---|---|---|---|---|---|---|
| | | | | Reference | Ink | from | from | | | |
| | | Lightness | | application | application | Expression | Expression | | | |
| Test | Fabric | difference | Presence of | amount A | amount y | (1) | (2) | y/A | | |
| No. | type | [—] | pretreatment? | [g/m²] | [g/m²] | [g/m²] | [g/m²] | [—] | Density | Texture |
| 3-1 | Fabric C | 17.4 | Yes | 30.0 | 30.0 | 33.0 | 33.6 | 1.0 | C | A |
| 3-2 | Fabric C | 17.4 | Yes | 30.0 | 33.0 | | | 1.1 | B | A |
| 3-3 | Fabric C | 17.4 | Yes | 30.0 | 39.0 | | | 1.3 | A | A |
| 3-4 | Fabric C | 17.4 | Yes | 30.0 | 45.0 | | | 1.5 | A | B |
| 3-5 | Fabric C | 17.4 | Yes | 30.0 | 60.0 | | | 2.0 | A | B |

### [Test 4]

An image was formed in the same manner as in Test 2 except that the pretreatment liquid, the ink 1, and the post-treatment liquid prepared above were applied onto the fabric D by sequentially ejecting the pretreatment liquid, the ink 1, and the post-treatment liquid from the inkjet heads, and the same evaluation was performed.

Table 5 shows the evaluation results of Tests 4-1 to 4-5.

TABLE 5

| | | | | | | y calculated | y calculated | | | |
|---|---|---|---|---|---|---|---|---|---|---|
| | | | | Reference | Ink | from | from | | | |
| | | Lightness | | application | application | Expression | Expression | | | |
| Test | Fabric | difference | Presence of | amount A | amount y | (1) | (2) | y/A | | |
| No. | type | [—] | pretreatment? | [g/m²] | [g/m²] | [g/m²] | [g/m²] | [—] | Density | Texture |
| 4-1 | Fabric D | 10.4 | Yes | 30.0 | 30.0 | 37.8 | 37.2 | 1.0 | C | A |
| 4-2 | Fabric D | 10.4 | Yes | 30.0 | 33.0 | | | 1.1 | C | A |
| 4-3 | Fabric D | 10.4 | Yes | 30.0 | 39.0 | | | 1.3 | B | A |
| 4-4 | Fabric D | 10.4 | Yes | 30.0 | 45.0 | | | 1.5 | A | B |
| 4-5 | Fabric D | 10.4 | Yes | 30.0 | 60.0 | | | 2.0 | A | B |

### [Test 5]

An image was formed in the same manner as in Test 2 except that the pretreatment liquid, the ink 2, and the post-treatment liquid prepared above were applied onto the fabric D by sequentially ejecting the pretreatment liquid, the ink 2, and the post-treatment liquid from the inkjet heads, and the same evaluation was performed.

Table 6 shows the evaluation results of Tests 5-1 to 5-5.

TABLE 6

| | | | | | | y calculated | y calculated | | | |
|---|---|---|---|---|---|---|---|---|---|---|
| | | | | Reference | Ink | from | from | | | |
| | | Lightness | | application | application | Expression | Expression | | | |
| Test | Fabric | difference | Presence of | amount A | amount y | (1) | (2) | y/A | | |
| No. | type | [—] | pretreatment? | [g/m²] | [g/m²] | [g/m²] | [g/m²] | [—] | Density | Texture |
| 5-1 | Fabric D | 10.4 | Yes | 15.0 | 15.0 | 18.9 | 18.6 | 1.0 | C | A |
| 5-2 | Fabric D | 10.4 | Yes | 15.0 | 16.5 | | | 1.1 | C | A |
| 5-3 | Fabric D | 10.4 | Yes | 15.0 | 19.5 | | | 1.3 | B | A |
| 5-4 | Fabric D | 10.4 | Yes | 15.0 | 22.5 | | | 1.5 | A | A |
| 5-5 | Fabric D | 10.4 | Yes | 15.0 | 30.0 | | | 2.0 | A | A |

### [Discussion]

Also in Tables 4 to 6, similarly to the above, it was confirmed that when the ink having the reference application amount was applied, the density became insufficient (see Tests 3-1, 4-1, 5-1 and 5-2).

On the other hand, it was confirmed that when the ink was applied onto the fabric at an amount larger than the reference application amount, a sufficient density was obtained (see Tests 3-2 to 3-5, 4-2 to 4-5 and 5-3 to 5-5).

### INDUSTRIAL APPLICABILITY

According to the present invention, it is possible to form an image with less decrease in color density, for example, even on a fabric obtained with the use of fibers that are difficult to see through.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming method, comprising:
applying an ink containing a pigment to a fabric by an inkjet method, wherein
when a lightness difference ΔL* of the fabric calculated by an expression below is smaller than a reference value or when a content of the pigment in the fiber is greater than a reference value, an application amount of the ink in the applying is set to be greater than a reference application amount:
$$lightness difference Δ {L}^{*} = ( lightness {L}^{*} measured in a state where the fabric is disposed on a standard white plate ) - ( lightness {L}^{*} measured in a state where the fabric is disposed on a standard black plate ) .$$

2. The image forming method according to claim 1, wherein
when the lightness difference ΔL* is smaller than the reference value,
in the applying, when x is the lightness difference ΔL* of the fabric, y [g/m²] is the application amount of the ink, and A [g/m²] is the reference application amount, the ink is applied so as to satisfy Expression (1) below:
$$y \geq ( - 0.023 x + 1.5 ) \times A . \qquad Expression ( 1 )$$

3. The image forming method according to claim 1, wherein
when the lightness difference ΔL* is greater than the reference value,
in the applying, the ink is applied at the reference application amount.

4. An image forming method, comprising:
applying an ink containing a pigment to a fabric by an inkjet method, wherein
in the applying, when x is a lightness difference ΔL* of the fabric calculated by an expression below, y [g/m²] is an application amount of the ink, and A [g/m²] is a reference application amount, the ink is applied so as to satisfy Expression (1) below:
$$y \geq ( - 0.023 x + 1.5 ) \times A , and \qquad Expression ( 1 )$$
$$lightness difference Δ {L}^{*} = ( lightness {L}^{*} measured in a state where the fabric is disposed on a standard white plate ) - ( lightness {L}^{*} measured in a state where the fabric \\ is disposed on a standard black plate ) ,$$
or when z [g/g] is a content of the pigment in the fiber, y [g/m²] is an application amount of the ink, and A [g/m²] is a reference application amount, the ink is applied so as to satisfy Expression (2) below:
$$y \geq ( 8. z + 1. ) \times A . \qquad Expression ( 2 )$$

5. The image forming method according to claim 1, wherein
when the content of the pigment in the fiber is greater than the reference value,
in the applying, when z [g/g] is the content of the pigment in the fiber, y [g/m²] is the application amount of the ink, and A [g/m²] is the reference application amount, the ink is applied so as to satisfy Expression (2) below:
$$y \geq ( 8. z + 1. ) \times A . \qquad Expression ( 2 )$$

6. The image forming method according to claim 1, wherein
the pigment in the fiber contains a white pigment.

7. The image forming method according to claim 4, wherein
in the applying, the ink containing a pigment is applied to a fabric that contains 0.01 g/g or more of a white pigment in a fiber thereof by an inkjet method at an application amount of the ink of 18.6 g/m² or more.

8. The image forming method according to claim 1, further comprising:
applying a treatment liquid containing an aggregating agent to a region of the fabric, the region being a region to which the ink is applied.

9. The image forming method according to claim 8, wherein
the aggregating agent contains at least one or more of an organic acid, a metal salt, and a water-soluble cationic resin.

10. The image forming method according to claim 1, wherein
the lightness difference ΔL* of the fabric is 20 or less.

11. The image forming method according to claim 1, wherein
the lightness L* of the fabric measured on the standard white plate is 95 or more and 100 or less.

12. The image forming method according to claim 1, wherein
the fabric contains a polyester fiber.

13. An image forming apparatus, comprising:
an inkjet head configured to eject an ink onto a fabric; and
a controller configured to control the inkjet head so as to set an application amount of the ink corresponding to a lightness difference of the fabric calculated by an expression below or to a content of a pigment in a fiber of the fabric:
$$lightness difference Δ {L}^{*} = ( lightness {L}^{*} measured in a state where the fabric is disposed on a standard white plate ) - ( lightness {L}^{*} measured in a state where the fabric is disposed on a standard black plate ) .$$

14. The image forming apparatus according to claim 13, wherein
when the lightness difference is smaller than a reference value or the content of the pigment in the fiber of the fabric is greater than a reference value, the controller controls the inkjet head so as to set the application amount of ink to the fabric to be greater than a reference application amount.

15. The image forming apparatus according to claim 13, wherein
when x is the lightness difference ΔL* of the fabric calculated by the expression, y [g/m²] is the application amount of the ink, and A [g/m²] is a reference application amount, the controller controls the inkjet head so as to satisfy Expression (1) below:
$$y \geq ( - 0.023 x + 1.5 ) \times A . \qquad Expression ( 1 )$$

16. The image forming apparatus according to claim 13, wherein
when z [g/g] is the content of the pigment in the fiber, y [g/m²] is the application amount of the ink, and A [g/m²] is a reference application amount, the controller controls the inkjet head so as to satisfy (2) below:
$$y \geq ( 8. z + 1. ) \times A . \qquad Expression ( 2 )$$
